(19) United States
(12) Patent Application Publication
(10) Pub. No.: US 2017/0327096 A1
(43) Pub. Date: Nov. 16, 2017

(54) VEHICLE REVERSE TRAVELING SPEED LIMITING APPARATUS

(71) Applicant: SUBARU CORPORATION, Tokyo (JP)

(72) Inventors: Kazuhito MOCHIDA, Tokyo (JP); Hiroyuki HASEGAWA, Tokyo (JP)

(21) Appl. No.: 15/483,907

(22) Filed: Apr. 10, 2017

(30) Foreign Application Priority Data
May 11, 2016 (JP) 2016-095415

(51) Int. Cl. B60T 8/32; B60T 8/34; B60T 8/17; B60T 8/24

(52) U.S. Cl. CPC B60T 8/3205; B60T 8/34; B60T 8/17; B60T 8/245; B60T 2230/08; B60T 8/246

(57) ABSTRACT

A vehicle reverse traveling speed limiting apparatus includes a fluid pressure detector, a brake driver, a limiting speed setter, and a reverse traveling speed controller. The fluid pressure detector detects a brake fluid pressure. The brake driver causes a main brake to perform braking based on a set instruction fluid pressure. The limiting speed setter sets a limiting speed upon reverse traveling. The reverse traveling speed controller executes torque and brake controls to allow an actual vehicle speed of a vehicle to be maintained at the limiting speed. When the actual vehicle speed is higher than the limiting speed, the reverse traveling speed controller sets the instruction fluid pressure to allow the actual vehicle speed to be converged to the limiting speed, and executes, even when the brake fluid pressure is higher than the instruction fluid pressure, the brake control to allow the instruction fluid pressure to be maintained.

### CROSS-REFERENCE TO RELATED APPLICATIONS

The present application claims priority from Japanese Patent Application No. 2016-095415 filed on May 11, 2016, the entire contents of which are hereby incorporated by reference.

### BACKGROUND

The technology relates to a vehicle reverse traveling speed limiting apparatus that limits a speed of a vehicle upon traveling in reverse.

A vehicle has been known that is mounted with a reverse traveling speed limiting apparatus. The reverse traveling speed limiting apparatus allows the vehicle to travel in reverse at a preset limiting speed without a driver's operation of pressing down on an accelerator pedal upon, for example, parking the vehicle at a parking lot by driving the vehicle in reverse. The reverse traveling speed limiting apparatus also serves to prevent the vehicle from traveling suddenly upon the reverse traveling when a driver erroneously presses down on the accelerator pedal with the intention of pressing down on a brake pedal.

For example, Japanese Unexamined Patent Application Publication No. 2013-1296 discloses a technique that limits a reverse traveling speed to a set speed until predetermined time elapses. The reverse traveling speed is limited when a driver sets a selector lever to a reverse (R) range and a brake switch is switched from an “ON” state to an “OFF” state. The “ON” state corresponds to pressing down of a brake pedal, and the “OFF” state corresponds to releasing of the brake pedal. The preset speed is about 10 km/h.

### SUMMARY

In general, it is desirable that a reverse traveling speed limiting apparatus achieve stable controllability.

It is desirable to provide a vehicle reverse traveling speed limiting apparatus that is able to achieve stable controllability.

An aspect of the technology provides a vehicle reverse traveling speed limiting apparatus that includes: a fluid pressure detector that detects a brake fluid pressure generated on a basis of a braking operation performed by a driver; a brake driver that causes a main brake to perform braking on a basis of a set instruction fluid pressure; a limiting speed setter that sets a limiting speed upon reverse traveling of a vehicle; and a reverse traveling speed controller that executes, when setting of the reverse traveling is detected, a torque control and a brake control to allow an actual vehicle speed of the vehicle to be maintained at the limiting speed. The brake control is performed on the brake driver and is based on setting of the instruction fluid pressure. When the actual vehicle speed is detected as being higher than the limiting speed, the reverse traveling speed controller sets the instruction fluid pressure to allow the actual vehicle speed to be converged to the limiting speed, and executes, even when the brake fluid pressure is detected as being higher than the instruction fluid pressure set by the reverse traveling speed controller, the brake control to allow the instruction fluid pressure set by the reverse traveling speed controller to be maintained.

The vehicle reverse traveling speed limiting apparatus may further include a vehicle speed detector that detects the actual vehicle speed.

The vehicle reverse traveling speed limiting apparatus may further include a setting detector that detects the setting of the reverse traveling.

The setting detector may detect the setting of the reverse traveling by detecting setting of a shift lever to a reverse range.

### BRIEF DESCRIPTION OF THE DRAWINGS

FIG. 1 schematically illustrates a vehicle on which a vehicle reverse traveling speed limiting apparatus according to an implementation of the technology is mounted.

FIG. 2 illustrates an example of a configuration of the vehicle reverse traveling speed limiting apparatus.

FIG. 3 is a flowchart illustrating an example of a routine directed to a reverse traveling speed limiting process.

FIG. 4 is a flowchart illustrating an example of a subroutine directed to a target torque calculating process.

FIG. 5 is a flowchart illustrating an example of a subroutine directed to an instruction fluid pressure calculating process.

FIG. 6 is a timing chart illustrating an example of a relationship between an instruction fluid pressure set upon reverse traveling and a brake fluid pressure generated as a result of pressing down of a brake pedal.

### DETAILED DESCRIPTION

In the following, a description is given of one implementation of the technology with reference to the accompanying drawings.

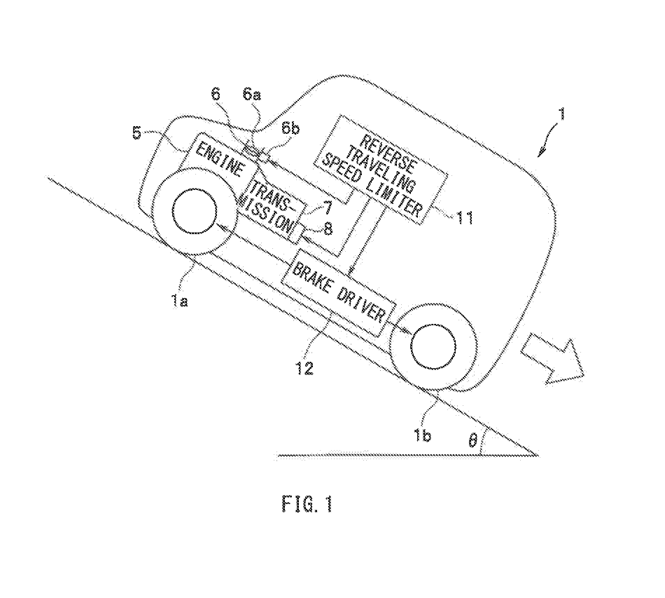

Referring to FIG. 1, a vehicle or an “own vehicle” 1 may have right and left front wheels 1a and right and left rear wheels 1b. The own vehicle 1 may be a four-wheel-drive vehicle in an illustrated example. The own vehicle 1 may be mounted with an engine 5 and an electronic control throttle 6 provided in an inlet system of the engine 5. The electronic control throttle 6 may have a throttle valve 6a that is opened and closed freely by a throttle actuator 6b. The own vehicle 1 may further include an automatic transmission 7 coupled to an output of the engine 5. For example, the automatic transmission 7 may include a torque converter and a transmission such as a continuously variable transmission and a multistage transmission. The automatic transmission 7 may vary an output of the engine 5 to a given output by means of a shift change, and transmit the varied output to the drive wheels 1a and 1b. The transmission provided in the automatic transmission 7 may perform a speed change operation on the basis of a drive signal supplied from a speed change controller 8.

Further, the own vehicle 1 includes a reverse traveling speed limiter 11 that limits a speed upon traveling in reverse. In one implementation, the reverse traveling speed limiter 11 may serve as a “reverse traveling speed controller”. The reverse traveling speed limiter 11 may be mainly configured by a known microcomputer that includes devices such as a central processing unit (CPU), a read only memory (ROM), and a random access memory (RAM). The ROM may contain control programs that achieve predetermined operations and fixed data such as various tables.

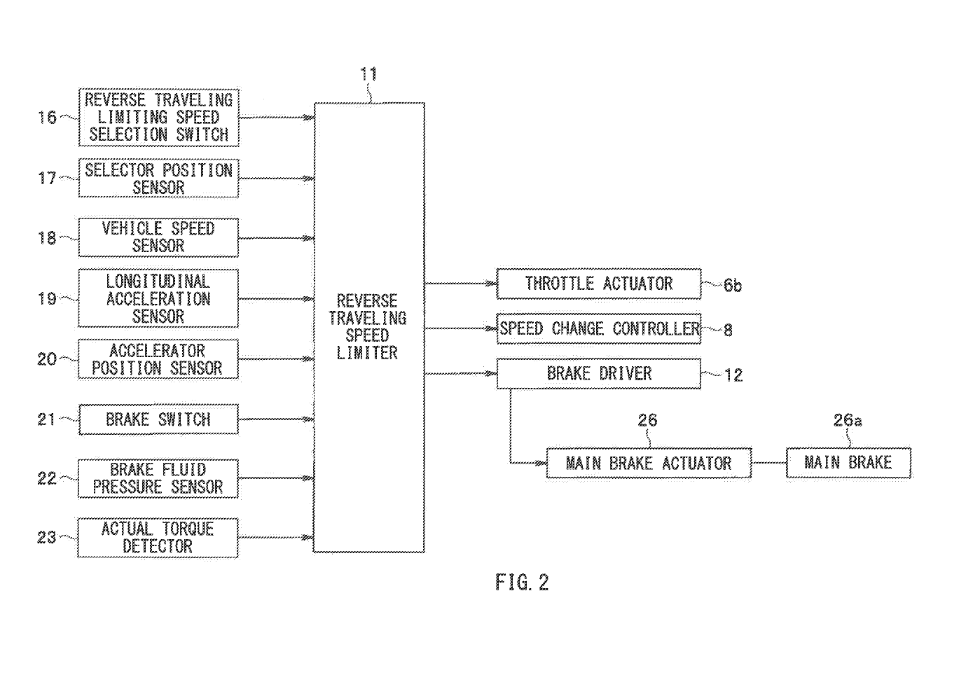

FIG. 2 illustrates an example of a configuration of the vehicle reverse traveling speed limiting apparatus according to the present implementation. The reverse traveling speed limiter 11 may be coupled to various sensors and switches that are necessary in controlling a limiting speed when the own vehicle 1 travels in reverse. Non-limiting examples of the various sensors and switches may include a reverse traveling limiting speed selection switch 16, a selector position sensor 17, a vehicle speed sensor 18, a longitudinal acceleration sensor 19, an accelerator position sensor 20, a brake switch 21, a brake fluid pressure sensor 22, and an actual torque detector 23. The reverse traveling limiting speed selection switch 16 may be provided at an unillustrated driver's seat, and allow a driver to set the limiting speed upon the reverse traveling. In one implementation, the reverse traveling limiting speed selection switch 16 may serve as a “limiting speed setter”. The selector position sensor 17 may detect a range position of a selector lever set by the driver. In one implementation, the selector position sensor 17 may serve as a “setting detector” or a “selector position detector”. In one implementation, the selector lever may serve as a shift lever. The vehicle speed sensor 18 may detect a vehicle speed, or an “actual vehicle speed”, of the own vehicle 1. In one implementation, the vehicle speed sensor 18 may serve as a “vehicle speed detector”. The longitudinal acceleration sensor 19, or a “longitudinal accelerometer”, may measure a slope of a traveling surface (i.e., a road surface slope) “θ” on the basis of an acceleration rate G in a front-rear direction of the own vehicle 1. The accelerator position sensor 20 may detect a position of an accelerator on the basis of a pressing amount of an accelerator pedal. The brake switch 21 may detect pressing down of a brake pedal and thereby output an “ON” signal. In one implementation, the brake switch 21 may serve as a “braking operation detector”. The brake fluid pressure sensor 22 may detect a brake fluid pressure of a master cylinder. In one implementation, the brake fluid pressure sensor 22 may serve as a “fluid pressure detector”. The actual torque detector 23 may detect an actual torque of the engine 5, or an “actual engine torque”. These sensors and switches may be coupled to an input of the reverse traveling speed limiter 11.

The reverse traveling limiting speed selection switch 16 may be an external switch that allows the driver to select the limiting speed upon the reverse traveling, or a “reverse traveling limiting speed”. For example, the reverse traveling limiting speed selection switch 16 may allow the driver to set the limiting speed to any of four levels of speed including a low speed, a medium speed, a high speed, and OFF. The limiting speed may not be set when OFF is selected. The low speed, the medium speed, and the high speed may respectively be 10 km/h, 15 km/h, and 20 km/h, which may be set in advance, for example. In the present implementation, the actual torque detector 23 may determine the actual engine torque on the basis of the revolutions per minute of the engine 5 and a parameter that indicates an engine load while referring to a map. The parameter that indicates the engine load may be an intake airflow rate.

The reverse traveling speed limiter 11 may also be coupled to the throttle actuator 6b, the speed change controller 8, and a brake driver 12. In one implementation, the brake driver 12 may serve as a “brake driver”. The brake driver 12 may cause a main brake actuator 26 to operate. The main brake actuator 26 may increase and decrease a brake fluid pressure supplied from a hydraulic control unit (HCU) provided in the brake driver 12 to adjust braking force applied to a main brake 26a. The main brake 26a may be provided for each of the drive wheels 1a and 1b, and may be any brake such as a disc brake. The main brake 26a may be so configured that desired braking force is achieved also by the brake fluid pressure of the master cylinder generated as a result of a foot braking operation performed by the driver. The throttle actuator 6b, the speed change controller 8, and the brake driver 12 may be coupled to an output of the reverse traveling speed limiter 11.

When the driver operates the reverse traveling limiting speed selection switch 16 to select any of the reverse traveling limiting speeds, the reverse traveling speed limiter 11 may output drive signals to the throttle actuator 6b of the electronic control throttle 6, to the speed change controller 8, and to the brake driver 12 on the basis of parameters detected by the various sensors and switches. By outputting the drive signals, the reverse traveling speed limiter 11 so controls the vehicle speed of the own vehicle 1 traveling in reverse that the vehicle speed is kept to the limiting speed.

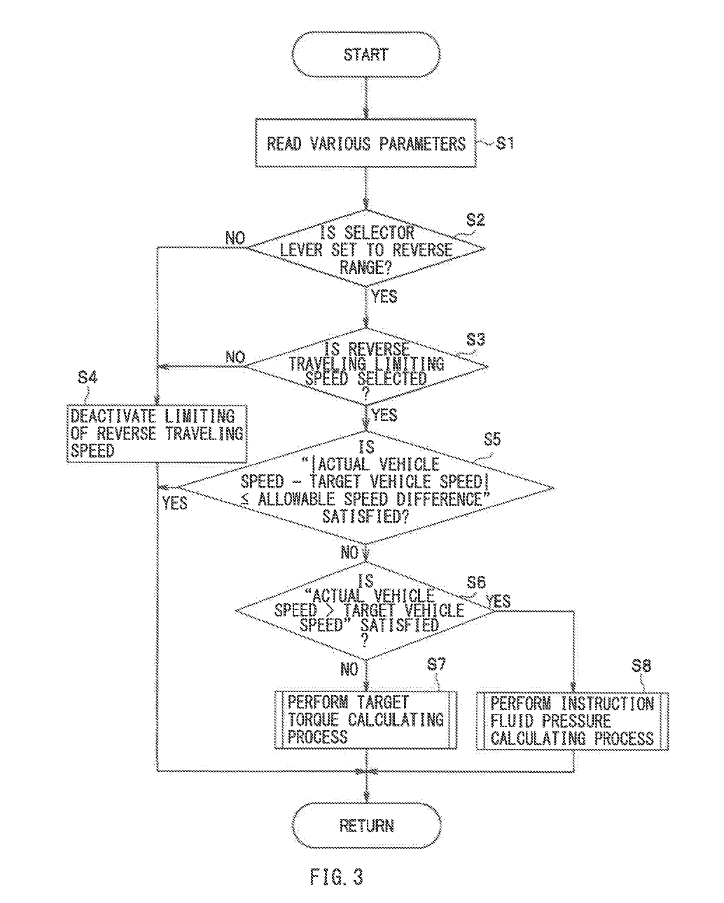

The reverse traveling speed limiter 11 may perform a process of limiting the reverse traveling speed upon the reverse traveling of the own vehicle 1, in accordance with a routine of the reverse traveling speed limiting process illustrated by way of example in FIG. 3.

In the example routine illustrated in FIG. 3, the various parameters detected by the various sensors and switches may be read first in step S1. Thereafter, the flow may proceed to step S2 in which a determination may be made as to whether the selector lever is set to the reverse range, on the basis of a signal supplied from the selector position sensor 17. The flow may proceed to step S3 when the determination is made that the selector lever is set to the reverse range (S2: YES). The flow may jump to step S4 when the determination is made that the selector lever is set to any range other than the reverse range (S2: NO).

In step S3, a determination may be made as to whether any reverse traveling limiting speed is selected, on the basis of a signal supplied from the reverse traveling limiting speed selection switch 16 operated by the driver. The flow may proceed to step S4 when the determination is made that “OFF” is selected for the reverse traveling limiting speed (S3: NO). The flow may proceed to step S5 when the determination is made that the reverse traveling limiting speed is set (S3: YES).

In step S4, the limiting of the reverse traveling speed is deactivated, following which the routine may be terminated. In this case, the reverse traveling speed may be set to a speed that is based on an amount of pressing down of the accelerator pedal performed by the driver or an amount of pressing down of the brake pedal performed by the driver even when the selector lever is set to the reverse range. Further, the reverse traveling speed may involve a creep speed when the accelerator pedal is released.

In step S5 following step S3, the reverse traveling limiting speed selected by the driver through operating the reverse traveling limiting speed selection switch 16, i.e., any of the low speed, the medium speed, and the high speed, may be set as a target vehicle speed. Further, in step S5, a determination may be made as to whether an absolute value of a difference between the actual vehicle speed detected by the vehicle speed sensor 18 and the target vehicle speed falls within a range of a preset allowable speed difference. In other words, a determination may be made as to whether the absolute value of the difference is equal to or less than the allowable speed difference (absolute value of difference≦allowable speed difference). When the determination is made that the absolute value of the difference falls within the range of the allowable speed difference, i.e., the expression “absolute value of difference≦allowable speed difference” is satisfied (S5: YES), a control currently performed may be maintained following the termination of the routine.

When the determination is made that the absolute value of the difference falls outside the range of the allowable speed difference, i.e., the expression “absolute value of difference>allowable speed difference” is satisfied (S5: NO), the flow may proceed to step S6 in which the actual vehicle speed may be compared with the target vehicle speed. When a result of the comparison indicates that the actual vehicle speed is less than the target vehicle speed, i.e., the expression “actual vehicle speed<target vehicle speed” is satisfied (S6: NO), the flow may proceed to step S7. In step S7, a torque control based on a target torque calculating process may be executed, following which the routine may be terminated. When the result of the comparison indicates that the actual vehicle speed is greater than the target vehicle speed, i.e., the expression “actual vehicle speed>target vehicle speed” is satisfied (S6: YES), the flow may diverge from step S6 to step S8 in which a brake control based on an instruction fluid pressure calculating process may be executed. The routine may be terminated following the execution of the instruction fluid pressure calculating process performed in step S8.

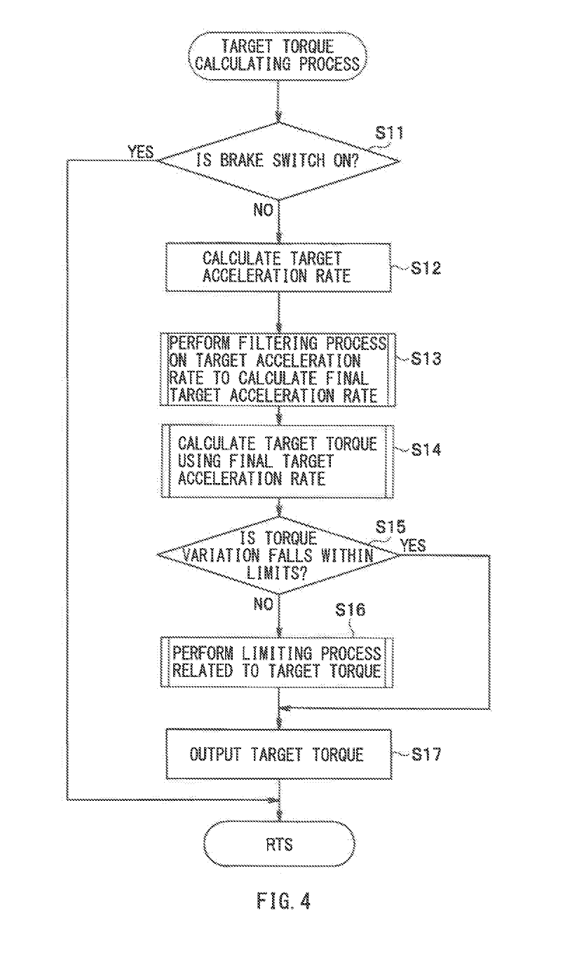

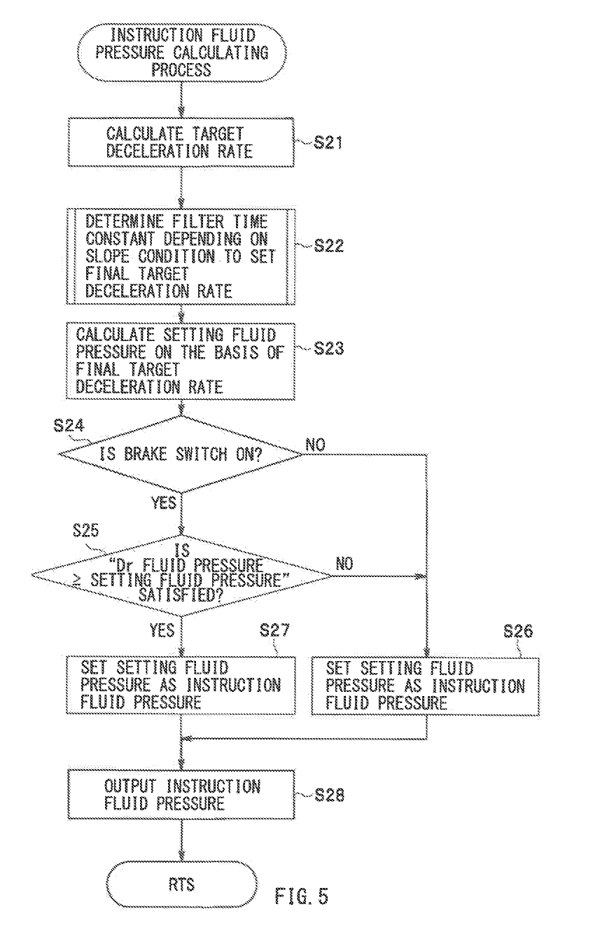

The target torque calculating process performed in step S7 may be executed in accordance with a subroutine directed to the target torque calculating process illustrated in FIG. 4. The instruction fluid pressure calculating process performed in step S8 may be executed in accordance with a subroutine directed to the instruction fluid pressure calculating process illustrated in FIG. 5.

A description is given first of the subroutine directed to the target torque calculating process. In the subroutine, first, a determination may be made as to whether the brake switch 21 is “ON” in step S11. When the determination is made that the brake switch 21 is “ON” (S11: YES), the routine may be terminated without setting a target torque so as to give priority to the driver. In this case, the deceleration may be performed by the main brakes 26a, by means of the brake fluid pressure generated as a result of the pressing down of the brake pedal performed by the driver.

When the determination is made that the brake switch 21 is “OFF” (S11: NO), the flow may proceed to step S12 in which time derivative of the difference between the actual vehicle speed and the target vehicle speed may be obtained to calculate a target acceleration rate. The target acceleration rate may be used to converge the vehicle speed of the own vehicle 1 to the target vehicle speed. Thereafter, in step S13, a first-order lag filter time constant may be set on the basis of the road surface slope θ measured by the longitudinal acceleration sensor 19. The road surface slope θ may be, in other words, an upward slope or a downward slope both on the flat ground. Further, in step S13, multiplication of the target acceleration rate by the thus-set filter time constant may be performed to calculate an ultimate target acceleration rate, i.e., a final target acceleration rate. The flow may proceed to step S14 following the calculation of the final target acceleration rate.

In step S14, the target torque may be calculated on the basis of the final target acceleration rate and a gear ratio of the automatic transmission 7. Following the calculation of the target torque, the flow may proceed to step S15 in which a torque variation may be determined on the basis of a difference between the actual engine torque and the target torque. The actual engine torque may be determined on the basis of the revolutions per minute of the engine 5 and the parameter directed to detection of the load of the engine 5 such as the intake airflow rate. Further, in step S14, a determination may be made as to whether the torque variation falls within limits of a preset limiting value.

When the determination is made that the torque variation exceeds the limiting value (S15: NO), the flow may diverge from step S15 to step S16 in which a limiting process related to the target torque may be performed in order to prevent a sudden fluctuation in torque. For example, the limiting process may involve adding the limiting value to the actual engine torque and setting the resultant as a current target torque. The flow may proceed to step S17 following the limiting process. The flow may jump to step S17 when the determination is made in step S15 that the torque variation, i.e., the variation in the target torque, falls within the limits of the limiting value (S15: YES). In step S17, the drive signals corresponding to the target torque may be outputted, following which the routine may be terminated.

The reverse traveling speed limiter 11 may set a target throttle position on the basis of the target torque, and may so perform a feedback control as to converge the actual engine torque to the target torque on the basis of the target throttle position. The reverse traveling speed limiter 11 may perform the feedback control by driving the throttle actuator 6b of the electronic control throttle 6 to pivot the throttle valve 6a on the basis of the target throttle position.

In one implementation where the automatic transmission 7 is a continuously variable transmission (CVT), the reverse traveling speed limiter 11 may set the target number of rotations of a primary pulley on the basis of the target torque and the reverse traveling limiting speed. Further, the reverse traveling speed limiter 11 may output, to the speed change controller 8, the gear ratio by which the number of rotations of the primary pulley is set to the target number of rotations thereof to thereby control the gear ratio of the automatic transmission 7.

In the subroutine directed to the instruction fluid pressure calculating process illustrated in FIG. 5, first, time derivative of the difference between the actual vehicle speed and the target vehicle speed may be obtained to calculate a target deceleration rate in step S21. The target deceleration rate may be used to converge the vehicle speed of the own vehicle 1 to the target vehicle speed.

The flow may thereafter proceed to step S22 in which a first-order lag filter time constant may be set on the basis of the road surface slope θ measured by the longitudinal acceleration sensor 19. Further, in step S22, multiplication of the target deceleration rate by the thus-set filter time constant may be performed to calculate an ultimate target deceleration rate, i.e., a final target deceleration rate. The flow may proceed to step S23 following the calculation of the final target deceleration rate.

In step S23, a setting fluid pressure for the brake fluid pressure may be calculated. The setting fluid pressure may be directed to the brake fluid pressure necessary to so cause the main brakes 26a to perform braking that the deceleration rate of the own vehicle 1 is set to the final target deceleration rate. Following the calculation of the setting fluid pressure, the flow may proceed to step S24 in which a determination may be made as to whether the driver presses down on the brake pedal, on the basis of the signal supplied from the brake switch 21. The flow may proceed to step S25 when the brake switch 21 is determined as being “ON”, i.e., when the determination is made that the driver presses down on the brake pedal (S24: YES). The flow may diverge from step S24 to step S26 when the brake switch 21 is determined as being “OFF”, i.e., when the determination is made that the driver releases the brake pedal (S24: NO).

In step S25, the brake fluid pressure in the master cylinder may be compared with the setting fluid pressure. The brake fluid pressure in the master cylinder may be generated as a result of the pressing down of the brake pedal (referred to as a “Dr fluid pressure”), and may be detected by the brake fluid pressure sensor 22. When a result of the comparison indicates that the Dr fluid pressure is less than the setting fluid pressure, i.e., the expression “Dr fluid pressure<setting fluid pressure” is satisfied (S25: NO), the flow may diverge from step S25 to S26. When the result of the comparison indicates that the Dr fluid pressure is equal to or greater than the setting fluid pressure, i.e., the expression “Dr fluid pressure≧setting fluid pressure” is satisfied (S25: YES), the flow may proceed to step S27.

When the flow proceeds to step S26 from step S24 or from step S25, the setting fluid pressure may be set as an instruction fluid pressure (instruction fluid pressure: setting fluid pressure), following which the flow may proceed to step S28. When the flow proceeds to step S27 from step S25, the setting fluid pressure may be set as the instruction fluid pressure (instruction fluid pressure: setting fluid pressure) as with step S26, following which the flow may proceed to step S28. In step S28, the instruction fluid pressure set in step S26 or in step S27 may be outputted, following which the routine may be terminated.

Thereafter, the reverse traveling speed limiter 11 may transmit a drive signal corresponding to the instruction fluid pressure to the brake driver 12. The brake driver 12 may thus cause the main brakes 26a to perform the braking through the main brake actuator 26 to thereby decelerate the own vehicle 1 to a predetermined vehicle speed.

It is to be noted that, in the process performed in the foregoing step S27, the setting fluid pressure is set as the instruction fluid pressure to cause the main brakes 26a to perform the braking as with step S26. It is to be also noted that the process of step S27 is performed without cancelling the setting fluid pressure unlike before, even when the Dr fluid pressure generated as a result of the pressing down of the brake pedal performed by the driver is higher than the setting fluid pressure. Accordingly, the setting fluid pressure is maintained continuously without involving a reduction, even when the driver presses down on the brake pedal.

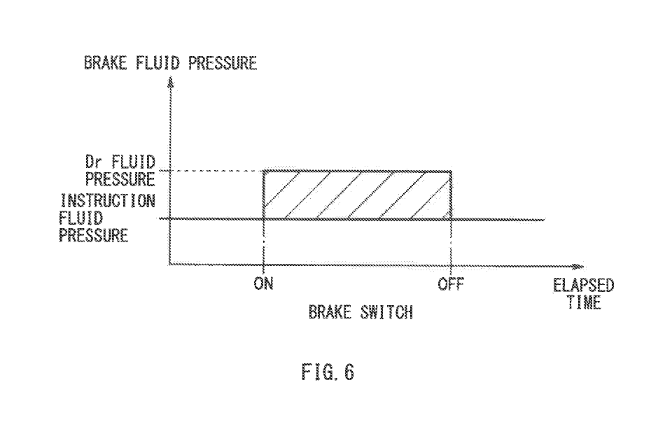

This means that, as illustrated in FIG. 6, the setting fluid pressure is sustained even after the driver releases the brake pedal (i.e., the brake switch 21 is turned off) and thus the Dr fluid pressure is drained, in an example situation where the actual vehicle speed is still higher than the target vehicle speed and the actual vehicle speed is not yet converged to the target vehicle speed. As a result, it is possible to prevent the brake liquid pressure from being exhausted for a moment, and thereby to prevent the own vehicle 1 from accelerating at a speed that exceeds the target vehicle speed. This is true even when, as illustrated by way of example in FIG. 1, the own vehicle 1 travels in reverse down a sloped road surface having the road surface slope θ while the driver presses down on the brake pedal to decelerate the own vehicle 1 and then the driver releases the brake pedal. In other words, it is possible to prevent the own vehicle 1 from accelerating at a speed defined as “target vehicle speed+extra vehicle speed”. Hence, it is possible to allow the own vehicle 1 to travel in reverse within a range of the limiting speed selected by the driver.

Note that, as with step S26, the setting fluid pressure calculated in step S23 is set as the instruction fluid pressure in the process performed in the foregoing step S27, meaning that the processes performed from steps S24 to S26 may be skipped to allow the flow to proceed to step S27 directly from step S23 in one implementation. In an alternative implementation, the instruction fluid pressure set in step S27 may be set to a value different from a value of the instruction fluid pressure set in step S26.

According to the present implementation thus described, the setting fluid pressure that maintains the limiting speed set as the target vehicle speed is retained continuously even when the driver presses down on the brake pedal to decelerate the own vehicle 1 in a situation where the selector lever is set to the reverse range and the own vehicle 1 travels down the slope in reverse. Thus, it is possible to prevent the driver from experiencing a feeling of sudden acceleration even when the driver releases the brake pedal, and thereby to achieve stable controllability. Hence, the driver is able to perform a delicate braking operation upon the reverse traveling without being aware of the exhaustion of the brake fluid pressure, achieving favorable brake operability.

Incidentally, a typical reverse traveling speed limiting apparatus controls a reverse traveling speed on the basis of a torque control and a brake control. Specifically, the reverse traveling speed limiting apparatus accelerates a vehicle by means of the torque control that utilizes an engine control and a speed change control when the reverse traveling speed is lower than a set speed, and decelerates the vehicle by means of the brake control to maintain the set speed when the reverse traveling speed is higher than the set speed.

A driver may also decelerate the vehicle by pressing down on a brake pedal when the driver feels that a speed of the vehicle traveling in reverse at the set speed is fast. In such a situation, a reverse traveling speed limiting operation performed in a reverse traveling speed limiting apparatus according to a comparative example is once cancelled when the driver presses down on the brake pedal, and the reverse traveling speed limiting operation is executed again when the driver releases the brake pedal thereafter.

However, in the reverse traveling speed limiting apparatus according to the comparative example, a certain time lag exists until the reverse traveling speed limiting operation is actually resumed even when the releasing of the brake pedal is detected. Accordingly, a concern arises that the driver may possibly experience a feeling of sudden acceleration due to the time lag that exists until the reverse traveling speed limiting operation is resumed, in an example situation where the driver presses down on the brake pedal to temporarily decelerate the vehicle and releases the brake pedal thereafter upon driving on a slope in reverse.

Although some preferred implementations of the technology have been described in the foregoing by way of example with reference to the accompanying drawings, the technology is by no means limited to the implementations described above.

For example, in one implementation, the actual engine torque may be detected directly by means of a torque sensor.

According to an implementation of the technology, the instruction fluid pressure that converges the vehicle speed to the limiting speed is not cancelled even when the driver presses down on the brake pedal to perform the deceleration upon the reverse traveling. Thus, it is possible to limit the reverse traveling speed immediately when the driver releases the brake pedal thereafter. Hence, it is possible to prevent the driver from experiencing a feeling of sudden acceleration even upon traveling down the slope in reverse, and thereby to achieve stable controllability.

It should be appreciated that modifications and alterations may be made by persons skilled in the art without departing from the scope as defined by the appended claims. The technology is intended to include such modifications and alterations in so far as they fall within the scope of the appended claims or the equivalents thereof.

1. A vehicle reverse traveling speed limiting apparatus comprising:
a fluid pressure detector that detects a brake fluid pressure generated on a basis of a braking operation performed by a driver;
a brake driver that causes a main brake to perform braking on a basis of a set instruction fluid pressure;
a limiting speed setter that sets a limiting speed upon reverse traveling of a vehicle; and
a reverse traveling speed controller that executes, when setting of the reverse traveling is detected, a torque control and a brake control to allow an actual vehicle speed of the vehicle to be maintained at the limiting speed, the brake control being performed on the brake driver and being based on setting of the instruction fluid pressure,
wherein, when the actual vehicle speed is detected as being higher than the limiting speed, the reverse traveling speed controller sets the instruction fluid pressure to allow the actual vehicle speed to be converged to the limiting speed, and executes, even when the brake fluid pressure is detected as being higher than the instruction fluid pressure set by the reverse traveling speed controller, the brake control to allow the instruction fluid pressure set by the reverse traveling speed controller to be maintained.

2. The vehicle reverse traveling speed limiting apparatus according to claim 1, further comprising a vehicle speed detector that detects the actual vehicle speed.

3. The vehicle reverse traveling speed limiting apparatus according to claim 1, further comprising a setting detector that detects the setting of the reverse traveling.

4. The vehicle reverse traveling speed limiting apparatus according to claim 2, further comprising a setting detector that detects the setting of the reverse traveling.

5. The vehicle reverse traveling speed limiting apparatus according to claim 3, wherein the setting detector detects the setting of the reverse traveling by detecting setting of a shift lever to a reverse range.

6. The vehicle reverse traveling speed limiting apparatus according to claim 4, wherein the setting detector detects the setting of the reverse traveling by detecting setting of a shift lever to a reverse range.
